(19) United States
(12) Patent Application Publication
(10) Pub. No.: US 2016/0297229 A1
(43) Pub. Date: Oct. 13, 2016

(54) Interactive entertaining pages or book with slits therein and a flat paper figure

(71) Applicant: Aleksandra Matyushenkova, Spring Valley, NY (US)

(72) Inventor: Aleksandra Matyushenkova, Spring Valley, NY (US)

(21) Appl. No.: 14/685,274

(22) Filed: Apr. 13, 2015

(51) Int. Cl. B42D 1/00

(52) U.S. Cl. CPC B42D 1/00

(57) ABSTRACT

A selected number of pages are arranged in book-like fashion and bound together so that the book may be disposed either with the pages flat on a support or in easel-like disposition. An interactive entertaining pages or book contain pages with specific slits therein and a flat paper figure. The paper figure may be placed in the slits, so that a child may play with a figure to arrange a representation of a daily living activities or a situation described in the story text.

### CROSS-REFERENCE TO RELATED APPLICATIONS

This application claims the benefit of provisional Patent Application No. 61/980,215 filed, Apr. 16, 2014 with United States Patent and Trademark office.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Flat paper figures have been and still are very popular among children. However traditional paper figures have some disadvantages. They all provide the same set: the variety of paper figures and paper wardrobe to dress the figures. In the end we have a paper figure and lots of small paper pieces of clothing that tear easily with children hands (especially young children, still developing their motor skills). This can lead to child's frustration, disappointment and disinterest. Besides these paper doll and wardrobe sets do not leave much room for development of imagination, which I believe to be crucial in children's play.

My invention designed to eliminate those drawbacks by incorporating flat paper figure and pages or book with sceneries and special slits therein so the figure can be put in, because participating in the daily activities through the figure, children learn about and understand the world around them.

The present invention relates to pages, books and the like; and more particularly, to books and the like with entertaining play effect.

### BRIEF SUMMARY OF THE INVENTION

The present invention is an interactive illustrated children's book or pages with specific slits therein and a flat paper figure to insert in the slits.

### BRIEF DESCRIPTION OF THE DRAWINGS

FIG. 1 pictorially illustrates a book in accordance with the present invention;

FIG. 2 is a view of a page of the present invention with a picture thereon and a slit therein;

FIG. 3 is a view of a paper flat figure of the present invention;

FIG. 4 is a view of a page with a flat paper figure inserted inside the slit of the book of FIG. 1 of the present invention.

### DETAILED DESCRIPTION OF THE INVENTION

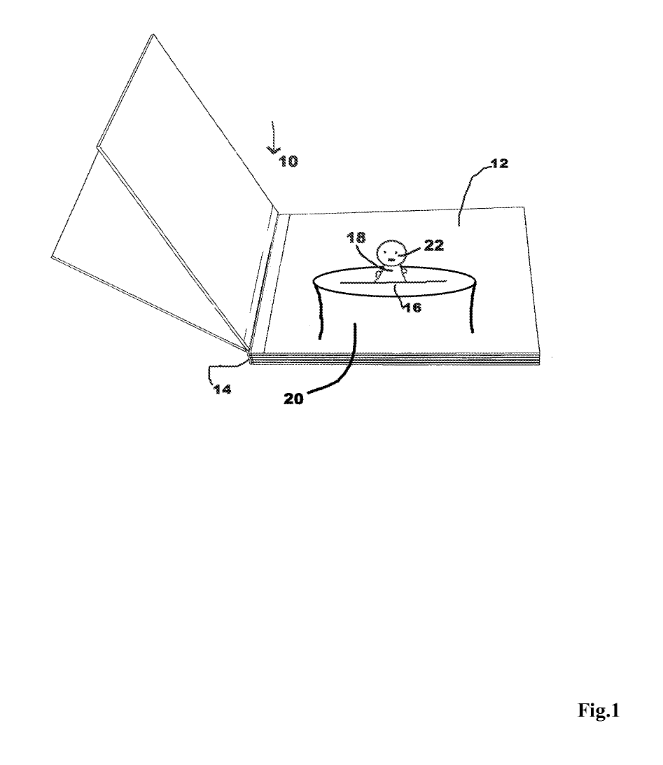

A book in accordance with the present invention is shown generally at 10 in FIG. 1 and comprises one or more pages 12 bound together in a book form (if needed) by a binding 14. Binding 14 may be formed in any suitable manner known in the book binding art. For example, a spiral wire binding or an adhesive may be used to bond the various pages 12 of book 10 together.

A preferred embodiment of the book 10 of the present invention is shown in FIG. 1 wherein at least one of the pages 12 of book 10, and preferably a plurality of pages 12 include an illustration 20 printed, painted, or otherwise disposed on at least a portion thereof. All illustrations may be accompanied by a text if needed. Any illustration 20 may be utilized and the invention is not meant to be limited to the examples shown in the figures.

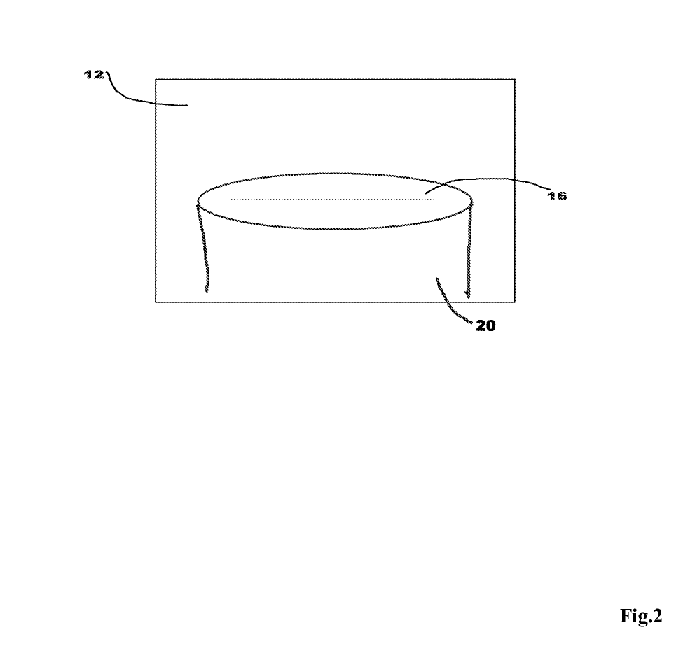

Referring now to FIG. 2 there is shown a view of a page 12 of the book 10. The page 12 includes an illustration 20 and a specific slit 16 made in any suitable manner. The specific slit 16 is required to correlate with an illustration 20 and to be able to accommodate FIG. 18.

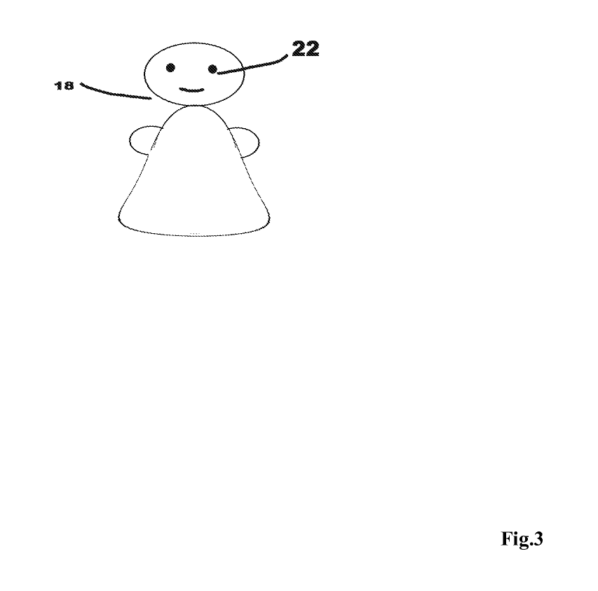

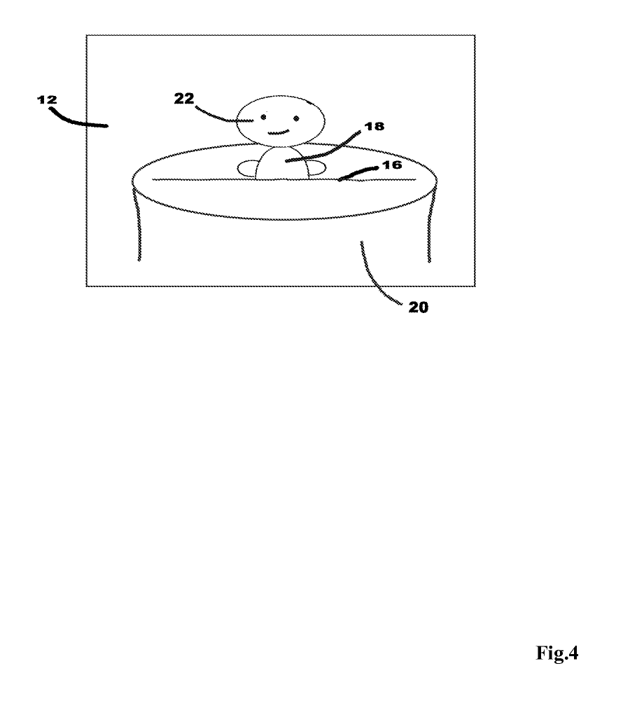

Referring now to FIG. 3 there is shown a FIG. 18 accompanying the book 10. The FIG. 18 can be formed from paper or any rigid or semi-rigid material and can include markings 22 representing features such as facial characteristics. These markings 22 may be formed in a number of ways such as by drawings, etching or painting. The FIG. 18 may represent any desired character, for example human beings, animals, storybook characters and the like. The invention is not limited to any particular type or shape of the figure, the only requirement being the ability of the figure to fit into the slit so it could complete an illustration 20 as shown in FIG. 4. FIG. 18 accompanying book 10 is preferably packaged along with the book as a page 12 and may be cut out.

The advantages of the present invention include, without limitation, that this book or pages provide educational play and children's cognitive development. Being simplex and easy to use, it allows children to learn about and understand the world around them through daily living activities. The book helps in developing essential skills such as concentration, sequential acts, story telling, cooperation, empathy, abstract thinking and imagination.

The invention should therefore not be limited by the above described embodiment, method, and examples, but by all embodiments and methods within the scope and spirit of the invention as claimed.

1. Interactive book or pages with slits therein and a flat paper figure comprising:
a book having a plurality of pages each of which includes a slit therein;
a flat paper figure.

2. The book of claim 1, wherein each page has a picture thereon;

3. The book of claim 2, wherein each page has a special slit, which is cut in accordance with the picture on the page;

4. The book of claim 3 further comprising a flat paper doll figure, which can be inserted in the slits.
